(19) United States
(12) Patent Application Publication
(10) Pub. No.: US 2020/0050244 A1
(43) Pub. Date: Feb. 13, 2020

(54) DETACHABLE STRUCTURE FOR SHIELDING INPUT/OUTPUT (I/O) PORTS

(71) Applicant: Nzxt Inc., City of Industry, CA (US)

(72) Inventor: Sam LIN, City of Industry, CA (US)

(21) Appl. No.: 16/136,634

(22) Filed: Sep. 20, 2018

(30) Foreign Application Priority Data
Aug. 8, 2018 (TW) 107210827

(51) Int. Cl. G06F 1/18

(52) U.S. Cl. CPC G06F 1/185; G06F 13/409; G06F 1/186; G06F 1/182

(57) ABSTRACT

A detachable structure for shielding input/output (I/O) ports of a motherboard includes a housing and a blocking plate. The housing has a plurality of installed portions, an internal space, and an opening, the internal space communicates with the opening, and the plurality of installed portions are arranged in the internal space. The housing is arranged on the motherboard, and the internal space accommodates the I/O ports. The blocking plate is penetrated with a plurality of first holes. A plurality of installing elements are respectively fixed to the installed portions to fix the blocking plate to the housing, thereby shielding the opening. The positions of the plurality of first holes respectively correspond to the positions of the I/O ports to use the plurality of first holes to expose the I/O ports.

### BACKGROUND OF THE INVENTION

### Field of the Invention

The present invention relates to a shielding structure, particularly to a detachable structure for shielding input/output (I/O) ports.

### Description of the Related Art

In general, the motherboard of a computer is fixed to a case. The case has an installed window whose position corresponds to the positions of input/output (I/O) ports of the motherboard. The I/O ports are emerged from the case and connected with external devices, such a mouse or a keyboard. However, since the I/O ports are delicate and highly required in size, the installed window has a shape of a rectangular. The installed window is provided with an input/output (I/O) blocking plate made of metal. The I/O blocking plate is penetrated with holes having various shapes to correspond to all of the I/O ports, so as to beautify the appearance of the case. Besides, the I/O blocking plate is used to prevent from electromagnetic interference (EMI) and electrostatic discharge (ESD) events.

The I/O blocking plate is fastened with the installed window of the case. Then, the I/O ports of the motherboard aim at the I/O blocking plate, so as to expose the I/O ports. The motherboard is fixed to the case through screws. However, due to the tolerance in fabrication, the sizes of the installed window and the I/O blocking plate have difference, such that the I/O ports do not aim at the I/O blocking plate. Thus, a part of the I/O ports are shielded by the I/O blocking plate. In other words, a user does not successfully use the I/O port. In addition, due to the tolerance, the user puts a lot of effort to snap the I/O blocking plate into the installed window. If the I/O blocking plate is made of metal, the user is easily slashed by the I/O blocking plate when installing the I/O blocking plate.

To overcome the abovementioned problems, the present invention provides a detachable structure for shielding input/output (I/O) ports, so as to solve the afore-mentioned problems of the prior art.

### SUMMARY OF THE INVENTION

The primary objective of the present invention is to provide a detachable structure for shielding input/output (I/O) ports, which uses a plurality of installing elements to fix a blocking plate to a motherboard instead of fixing the blocking plate to the case, thereby avoid the inconvenience of installation.

To achieve the abovementioned objectives, the present invention provides a detachable structure for shielding input/output (I/O) ports of a motherboard, and the detachable structure comprises: a housing having a plurality of installed portions, an internal space, and an opening, the internal space communicates with the opening, the plurality of installed portions are arranged in the internal space, the plurality of installed portions face toward the opening, the housing is arranged on the motherboard, and the internal space accommodates the I/O ports; and a blocking plate penetrated with a plurality of first holes, a plurality of installing elements are respectively fixed to the installed portions to fix the blocking plate to the housing, thereby shielding the opening, positions of the plurality of first holes respectively correspond to positions of the I/O ports to use the plurality of first holes to expose the I/O ports.

In an embodiment of the present invention, the plurality of installed portions are inserted holes, the blocking plate is penetrated with a plurality of installed holes, the plurality of installing elements are bolts, and the bolts are respectively inserted into the inserted holes through the plurality of installed holes, so as to fix the blocking plate to the housing.

In an embodiment of the present invention, the plurality of installed portions are screw holes, the blocking plate is penetrated with a plurality of installed holes, the plurality of installing elements are screws, and the screws are respectively inserted into the screw holes through the plurality of installed holes, so as to fix the blocking plate to the housing.

In an embodiment of the present invention, the plurality of installed portions are protruding portions, the plurality of installing elements are fasteners, and the fasteners are respectively fastened with the protruding portions, so as to fix the blocking plate to the housing.

In an embodiment of the present invention, the housing is fixed to the motherboard using screws.

In an embodiment of the present invention, the detachable structure further comprises a nameplate penetrated with a plurality of second holes, the nameplate is fixed to the blocking plate through an adhesive, and positions of the plurality of second holes respectively correspond to the positions of the plurality of first holes to expose the I/O ports.

In an embodiment of the present invention, the detachable structure further comprises a nameplate penetrated with a plurality of second holes, the blocking plate has first fasteners, the nameplate has second fasteners, the first fasteners are fastened with the second fasteners, so as to fix the nameplate to the blocking plate, and positions of the plurality of second holes respectively correspond to the positions of the plurality of first holes to expose the I/O ports.

Below, the embodiments are described in detail in cooperation with the drawings to make easily understood the technical contents, characteristics and accomplishments of the present invention.

### BRIEF DESCRIPTION OF THE DRAWINGS

FIG. 1 is a perspective view of a detachable structure for shielding input/output (I/O) ports according to an embodiment of the present invention;

FIG. 2 is an exploded view of a detachable structure for shielding input/output (I/O) ports according to an embodiment of the present invention;

FIG. 3 is a schematic diagram illustrating a blocking plate fixed to a housing through screws according to an embodiment of the present invention;

FIG. 4 is a schematic diagram illustrating a blocking plate fixed to a housing through bolts according to an embodiment of the present invention;

FIG. 5 is a schematic diagram illustrating a blocking plate fixed to a housing using protruding portions according to an embodiment of the present invention; and

FIG. 6 is a schematic diagram illustrating a nameplate fixed to a blocking plate through fasteners.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

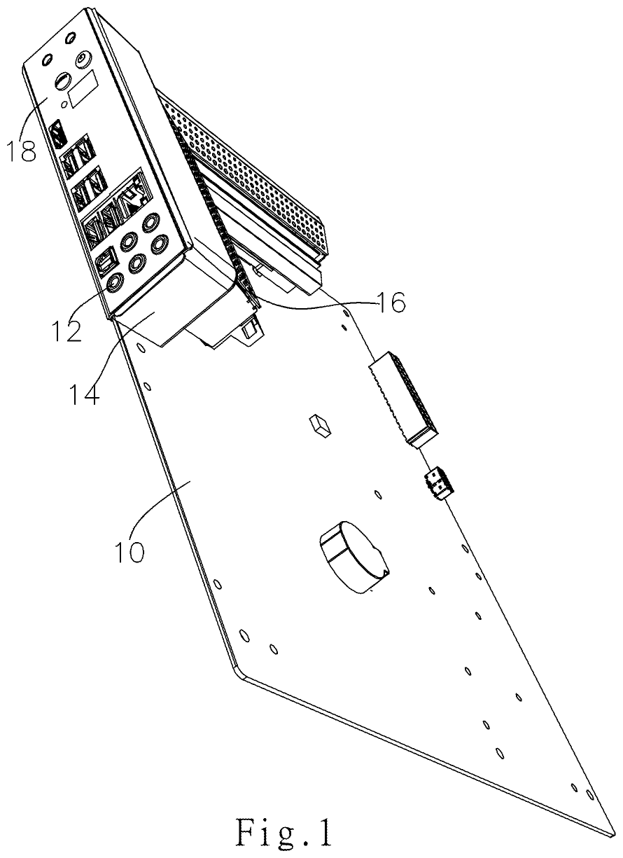

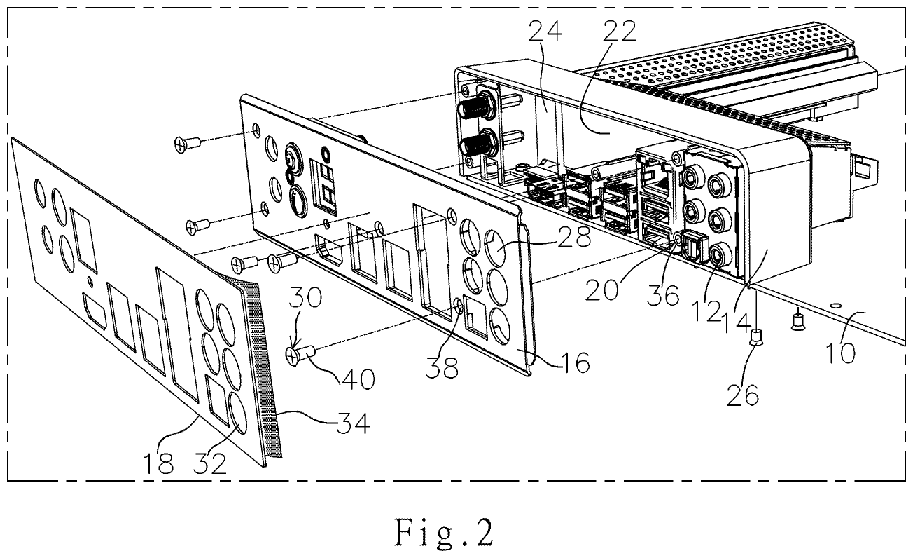

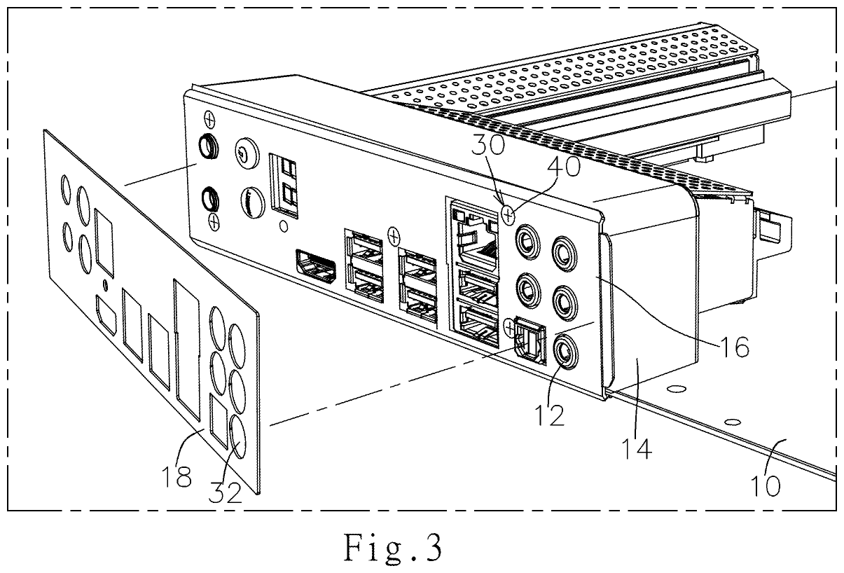

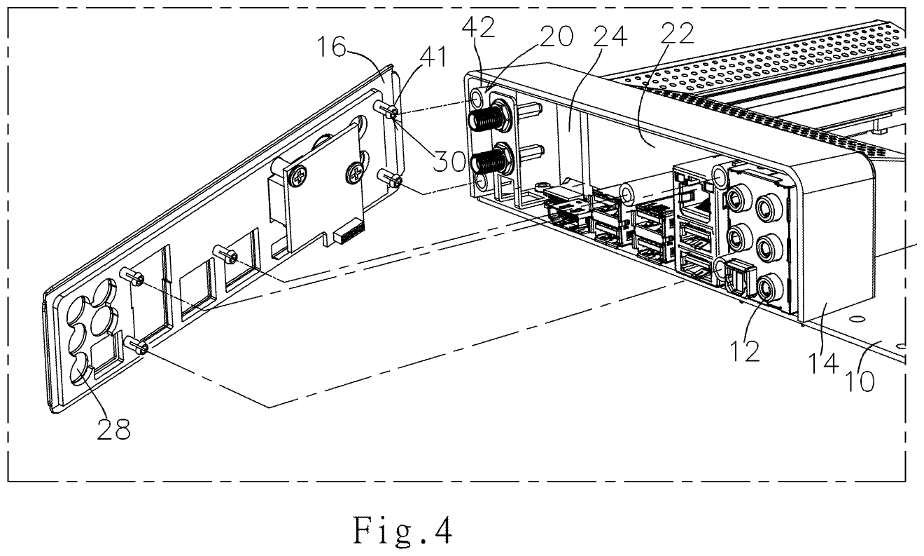

Refer to FIG. 1, FIG. 2, FIG. 3, and FIG. 4. The present invention provides a detachable structure for shielding input/output (I/O) ports. The detachable structure is installed on a motherboard 10 having I/O ports 12. The I/O ports 12 comprises a PS/2 port, a networking port, an audio port, or a universal serial bus (USB) port, but the present invention is not limited thereto. The detachable structure comprises a housing 14, a blocking plate 16, and a nameplate 18. For example, the housing 14 comprises plastic, the blocking plate 16 comprises metal, and the nameplate 18 comprises plastic. The housing 14 has a plurality of installed portions 20, an internal space 22, and an opening 24. The internal space 22 communicates with the opening 24, the plurality of installed portions 20 are arranged in the internal space 22, the plurality of installed portions 20 face toward the opening 24. The housing 14 is arranged on the motherboard 10, the internal space 22 accommodates the I/O ports 12. For example, the housing 14 is fixed to the motherboard 10 using screws 26. The blocking plate 16 is penetrated with a plurality of first holes 28. A plurality of installing elements 30 are respectively fixed to the installed portions 20 to fix the blocking plate 16 to the housing 14, thereby shielding the opening 24. The positions of the plurality of first holes 28 respectively correspond to positions of the I/O ports 12 to use the plurality of first holes 28 to expose the I/O ports 12. The plurality of installed portions 20 are not arranged on the exterior of the housing 14 since the housing 14 is arranged within the case. If the plurality of installed portions 20 are arranged on the exterior of the housing 14, the plurality of installed portions 20 are not fixed to the plurality of installing elements 30 due to the fact that the plurality of installed portions 20 are arranged in the case. The nameplate 18 is penetrated with a plurality of second holes 32. The nameplate 18 is fixed to the blocking plate 16 through an adhesive 34. The positions of the plurality of second holes 32 respectively correspond to the positions of the plurality of first holes 28 to expose the I/O ports 12. Specifically, the plurality of installed portions 20 are screw holes 36, the blocking plate 16 is penetrated with a plurality of installed holes 38, the plurality of installing elements 30 are screws 40, and the screws 40 are respectively inserted into the screw holes 36 through the plurality of installed holes 38, so as to fix the blocking plate 16 to the housing 14.

In addition to the screws 40, the plurality of installing elements 30 are alternatively bolts 41, as shown in FIG. 4. The plurality of installed portions 20 are inserted holes 42. The bolts 41 are respectively inserted into the inserted holes 42 through the plurality of installed holes 38, so as to fix the blocking plate 16 to the housing 14.

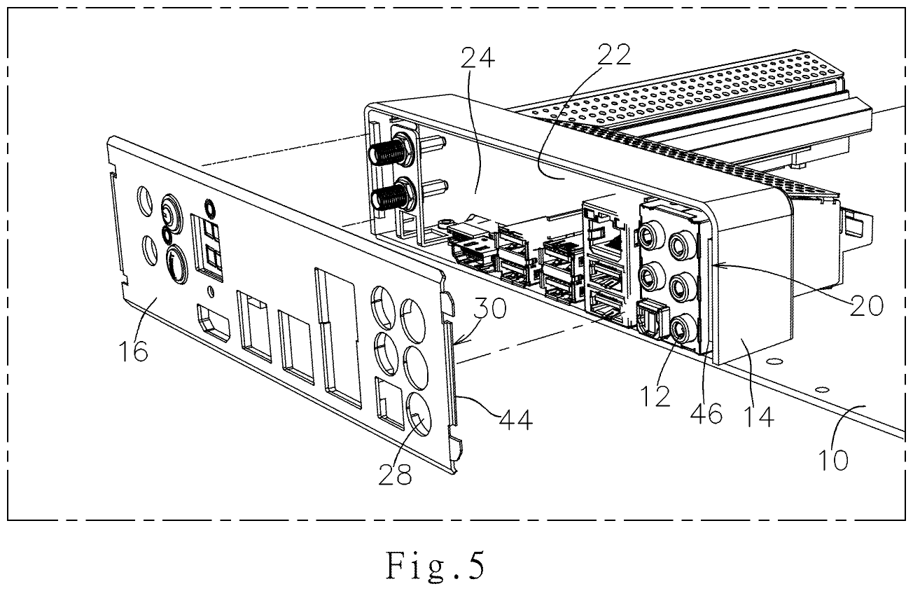

In addition to bolts and screws, the plurality of installing elements 30 are alternatively fasteners 44, as shown in FIG. 5. The plurality of installed portions 20 are protruding portions 46, and the fasteners 44 are respectively fastened with the protruding portions 46, so as to fix the blocking plate 16 to the housing 14.

In other words, the plurality of installing elements 30 may be bolts, screws, or fasteners and fixed to the plurality of installed portions 20. Bolts, screws, and fasteners are detachable elements. Thus, the blocking plate 16 is disassembled from the housing 14. The present invention uses the plurality of installing elements 30 to fix the blocking plate 16 to the motherboard 10 instead of fixing the blocking plate 16 to the case, thereby avoid the inconvenience of installation.

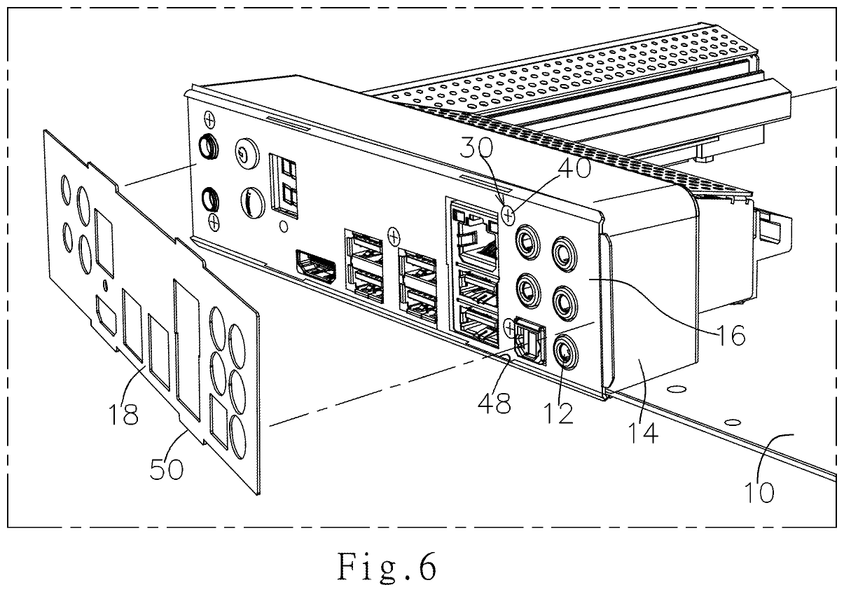

The nameplate 18 is fixed to the blocking plate 16 through the adhesive and in addition to that the blocking plate 16 has first fasteners 48 and the nameplate 18 has second fasteners 50, as shown in FIG. 6. The first fasteners 48 are fastened with the second fasteners 50, so as to fix the nameplate 18 to the blocking plate 16. This way, the nameplate 18 is disassembled from the blocking plate 16.

In conclusion, the present invention uses the plurality of installing elements to fix the blocking plate to the motherboard instead of fixing the blocking plate 16 to the case, thereby avoid the inconvenience of installation.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A detachable structure for shielding input/output (I/O) ports of a motherboard, and the detachable structure comprising:
a housing having a plurality of installed portions, an internal space, and an opening, the internal space communicates with the opening, the plurality of installed portions are arranged in the internal space, the plurality of installed portions face toward the opening, the housing is arranged on the motherboard, and the internal space accommodates the I/O ports; and
a blocking plate penetrated with a plurality of first holes, a plurality of installing elements are respectively fixed to the installed portions to fix the blocking plate to the housing, thereby shielding the opening, positions of the plurality of first holes respectively correspond to positions of the I/O ports to use the plurality of first holes to expose the I/O ports.

2. The detachable structure according to claim 1, wherein the plurality of installed portions are inserted holes, the blocking plate is penetrated with a plurality of installed holes, the plurality of installing elements are bolts, and the bolts are respectively inserted into the inserted holes through the plurality of installed holes, so as to fix the blocking plate to the housing.

3. The detachable structure according to claim 1, wherein the plurality of installed portions are screw holes, the blocking plate is penetrated with a plurality of installed holes, the plurality of installing elements are screws, and the screws are respectively inserted into the screw holes through the plurality of installed holes, so as to fix the blocking plate to the housing.

4. The detachable structure according to claim 1, wherein the plurality of installed portions are protruding portions, the plurality of installing elements are fasteners, and the fasteners are respectively fastened with the protruding portions, so as to fix the blocking plate to the housing.

5. The detachable structure according to claim 1, wherein the housing is fixed to the motherboard using screws.

6. The detachable structure according to claim 5, further comprising a nameplate penetrated with a plurality of second holes, the nameplate is fixed to the blocking plate through an adhesive, and positions of the plurality of second holes respectively correspond to the positions of the plurality of first holes to expose the I/O ports.

7. The detachable structure according to claim 6, wherein the nameplate comprises plastic.

8. The detachable structure according to claim 1, further comprising a nameplate penetrated with a plurality of second holes, the blocking plate has first fasteners, the nameplate has second fasteners, the first fasteners are fastened with the second fasteners, so as to fix the nameplate to the blocking plate, and positions of the plurality of second holes respectively correspond to the positions of the plurality of first holes to expose the I/O ports.

9. The detachable structure according to claim 8, wherein the nameplate comprises plastic.

10. The detachable structure according to claim 1, wherein the housing comprises plastic.

11. The detachable structure according to claim 1, wherein the blocking plate comprises metal.

12. The detachable structure according to claim 1, wherein the I/O ports comprise a PS/2 port, a networking port, an audio port, or a universal serial bus (USB) port.
